(19) United States
(12) Patent Application Publication
(10) Pub. No.: US 2005/0217587 A1
(43) Pub. Date: Oct. 6, 2005

(54) Device for and a method of detecting a disease of the udder of an animal

(76) Inventors: Lennart Nelson, Blentarp (SE); Lars Ove Sjaunja, Vange (SE)

Correspondence Address: HOVEY WILLIAMS LLP, 2405 GRAND BLVD., SUITE 400, KANSAS CITY, MO, 64108, US

(21) Appl. No.: 11/063,111

(22) Filed: Feb. 22, 2005

Related U.S. Application Data
(63) Continuation-in-part of application No. 09/762,225, filed on Apr. 5, 2001, now abandoned.

(30) Foreign Application Priority Data
Jul. 31, 1998 (SE) 9802653-7

(51) Int. Cl. A01J 5/013

(52) U.S. Cl. 119/14.02

(57) ABSTRACT

The invention refers to a device for and a method of detecting a disease of the udder of an animal. The device comprises means (9) for appreciating a parameter related to the quantity of milk extracted from a first and at least a second teat of said animal during at least one milking operation. Means (6) is arranged to determine a deviation of said parameter from a comparison value, and means (7) is arranged to display said deviation as an indication of an inflammation of the first teat in the case that said deviation exceeds a certain level. The determining means is arranged to define said comparison value by including the level of said parameter regarding said second teat during said milking operation.

This application is a continuation-in-part of application Ser. No. 09/762,225 filed 5 Apr., 2001, which is the National Stage of International Application No. PCT/SE99/01276 filed 15 Jul. 1999, which claims the benefit of Swedish Application No. 9802653-7 filed Jul. 31, 1998.

### BACKGROUND OF THE INVENTION AND PRIOR ART

The present invention refers to a device for detecting a disease of the udder of an animal, comprising means for appreciating a parameter related to the quantity of milk extracted from a first teat and at least a second teat of said animal during at least one milking operation, means arranged to determine a deviation of said parameter of the first teat from a comparison value, and means arranged to display said deviation as an indication of an inflammation of the first teat in the case that said deviation exceeds a certain level. Moreover, the invention refers to a method of detecting a disease of the udder of an animal, and to a milking arrangement comprising a device for detecting a disease of the udder of an animal, the device comprising means for appreciating a parameter related to the quantity of milk extracted from a first teat and at least a second teat of said animal during at least one milking operation, means arranged to determine a deviation of said parameter of the first teat from a comparison value, and means arranged to display said deviation as an indication of an inflammation of the first teat at least in the case that said deviation exceeds a certain level.

The present invention is concerned with udder inflammation of animals, i.e. mastitis, which may be caused by an infection of microorganisms, such as bacteria, but also be the result of a trauma or hormonal imbalances. In all milk production, mastitis constitutes a significant problem with respect to animal comfort, increased workload, reduced production capacity, etc.

In the past, different methods and devices have been proposed for identifying mastitis. Such methods and devices include, for instance, conductivity and temperature measurements on the milk extracted. Such measurements require a rather complicated equipment and the result thereof is still not very reliable. It is also known to identify mastitis by means of laboratory tests, which although reliable is rather inconvenient, since it might take many days before the result of such a test is received by the farmer.

Furthermore, it is known that one part of the udder of a cow, i.e. a quarter of the udder, may be inflamed by mastitis whereas the other quarters thereof are still healthy. Consequently, it is important to be able to identify any inflammation on an individual teat basis, i.e. for each quarter udder.

U.S. Pat. No. 4,325,028 discloses one example of a device for measuring the conductivity of the milk from each individual teat in a milk conduit between the teatcup and the claw in order to identify mastitis. The measurement equipment comprises a receiving device, provided in each such milk conduit and having electrodes located therein, and an electronic evaluation device. The constructions of the receiving devices are not described more closely. The aim of the device disclosed is to enable the determination whether the conductivity value of the milk from an individual teat is abnormal and thus whether any udder part is inflamed.

EP-B-137 367 discloses a milking device comprising measurement equipment for detecting the milk flow from an individual teat. The value detected may be employed for determining when the milking from this teat is to be interrupted. The measurement equipment comprises two electrodes for each milk flow to be detected.

U.S. Pat. No. 5,116,119 discloses an apparatus for measuring the milk flow through a flow channel. By means of electromagnetic radiation, the momentary volume and the momentary velocity of the milk flowing through the channel may be determined. Consequently, it is possible to determine the milk quantity of each milking operation.

JP-A-5 317 343 discloses a device for diagnosing mastitis. The quantity of milk from each udder part of a cow is measured during one milking operation. The relation between the milk quantity from each udder part and the total quantity is calculated. If the calculated relation deviates from the previously calculated relation by at least a pre-set value it is determined that the udder part in question is suffering from mastitis.

### SUMMARY OF THE INVENTION

The object of the present invention is to provide a device and a method for detecting a disease, in particular an inflammation, of an individual teat in a simple and reliable manner.

This object is obtained by the device initially defined and characterized in that the determining means is arranged to define said comparison value by including the level of said parameter regarding said second teat during the milking operation, wherein historical data, including pre-set milking parameters and/or data from one or several preceding milking operations, is considered when defining said comparison value.

It has appeared that a deviation in the quantity of milk produced by a teat in relation to a normal quantity may indicate mastitis in the udder and the particular teat from which the milk has been extracted. Consequently, by making use of this knowledge it is possible to detect mastitis in an easy and convenient manner and thereby take appropriate measures at an early stage to prevent the disease from infecting further udder parts or animals. It has been found that if the milk quantity of one udder part deviates from the milk quantity of an other udder part of one animal, there is high probability that the udder deviating is infected by mastitis. More specifically, the quantity of milk during one milking operation from the forward udder quarters is normally equal, as well as the quantity of milk from the two rearward udder parts, whereas the quantity of milk from one of the forward udder quarters normally differs by a certain percentage from the quantity of milk from one of the rearward udder quarters. Any deviation from said equality or from said percentage may indicate a disease such as mastitis in the actual udder part or teat.

Moreover, the first teat and said second teat may form one of a rearward pair of teats of the udder or a forward pair of teats of the udder. The milk yield from corresponding udder parts, e.g. from the two rear udder parts, is normally essentially equal whereas the milk yield from the rear udder parts is normally greater than the milk yield from the forward udder parts. Trials have shown that the difference in milk yield from a healthy udder part and an inflamed corresponding udder part might be 23%. By comparing corresponding udder parts in this manner, no historical data regarding previous milking operations are necessary for the indication of mastitis. Moreover, normal variations in the milk yield need not be considered according to this embodiment. The comparison value may be based on one single second teat or on two or three second teats, for instance, forming an average value of the remaining second teats.

According to a further embodiment of the present invention, said comparison value includes the level of said parameter of at least one preceding milking operation of said animal. It is also possible to compare, for instance, the milk yield from different milking operations of one and the same teat or udder part. By collecting such historical data over a longer period of time, it is possible to determine a normal average parameter regarding the milk yield, which then may be included in the comparison value. Preferably, the determining means is arranged to consider the time interval between the milking operation and the immediately preceding milking operation of said animal for determining said deviation. For instance, in voluntary milking systems, the time interval between successive milking operations may vary. In order to obtain a comparable value of said parameter, it is advantageous to take account of this time interval.

According to a further embodiment of the present invention, said parameter includes the quantity of milk produced during said milking operation and the appreciating means comprises a milk measuring device. In such a manner, a milk meter or any other liquid measuring device, such as any kind of liquid flow meter, may be employed for each teat or udder part for determining said parameter.

According to a further embodiment of the present invention, said parameter includes the time duration of said milking operation and the appreciating means includes a time measuring device. It is appreciated that the duration of the milking operation of one teat or udder part reflects the quantity of milk obtained during this milking operation. Consequently, by comparing the time duration of, for instance, the milking operation of two corresponding udder parts or between two successive milking operations of one teat or udder part, it is possible in an easy and convenient manner to detect an inflammation of an udder part.

The above object is also obtained by the method initially defined and comprising the steps of:
appreciating a parameter related to the quantity of milk extracted from a first teat and at least a second teat of said animal during at least one milking operation,
defining a comparison value by including the level of said parameter regarding said second teat during said milking operation,
determining a deviation of said parameter of the first teat from said comparison value, and
indicating an inflammation of the first teat in the case that said deviation exceeds a certain level, wherein historical data, including pre-set milking parameters and/or data from one or several preceding milking operations, is considered when defining said comparison value.

Advantageous embodiments of the method are defined in the dependent claims 9 to 14.

The above object is also obtained by the milking arrangement initially defined, which is characterized in that the determining means is arranged to define said comparison value by including the level of said parameter regarding said second teat during said milking operation, wherein historical data, including pre-set parameters and/or data from one or several preceding milking operations, is considered when defining said comparison value.

### BRIEF DESCRIPTION OF THE DRAWINGS

The present invention will now be described more closely by means of various embodiments and with reference to the accompanying drawings, in which

FIG. 1 shows a schematic view of a milking arrangement with a device according to the present invention, and

FIG. 2 shows a part of a device according to the present invention.

### DETAILED DESCRIPTION OF VARIOUS EMBODIMENTS OF THE PRESENT INVENTION

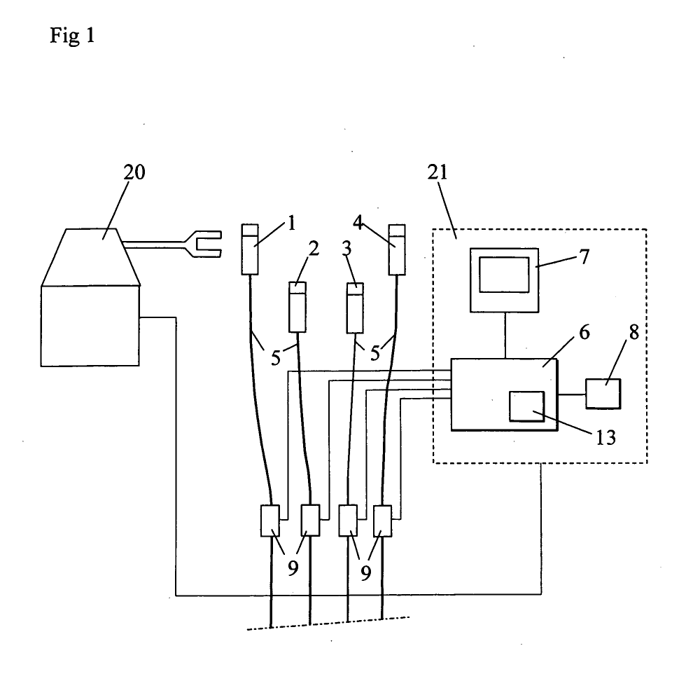

FIG. 1 discloses a device for indicating mastitis in any of the teats or udder parts of an animal. The device according to the invention is connected to a milking machine, which may be of a conventional type and which is merely represented in the drawings by four teatcups 1, 2, 3 and 4 and four milk conduits 5 connecting each teatcup 1-4 to a milk-receiving member of the milking machine.

The device according to the invention may also be included in a milking arrangement having an automatic handling device 20 for automatic attachment of the teatcups 1-4 to the teats of an animal, and having control system 21 for automatic supervision and control of the milking process.

In the following it is referred to milking of a respective teat. However, by this expression is meant milking of a respective udder part, i.e. one of the two rear udder parts or one of the two front udder parts. As an example, the teatcups 1, 4 may be intended for milking of the front udder parts whereas the teatcups 2, 3 are intended for milking of the rear udder parts.

The device comprises a processing unit 6 provided to determine a deviation in a parameter related to the quantity of milk extracted from any of the four teats from a comparison value. The processing unit 6 is connected to or incorporates a display member 7. The display member 7 may be of a number of different types. For instance a screen, a number of indicating lamps or diodes, one for each teat, producing a light signal when a teat is inflamed, or any display disclosing the size of the deviation leaving to the farmer to conclude if the deviation indicates an inflammation or not. Furthermore, the processing unit 6 may be connected to or incorporate a time measuring unit 8 arranged to measure the duration of a milking operation of a teat and/or the time period between two successive milking operations of a teat.

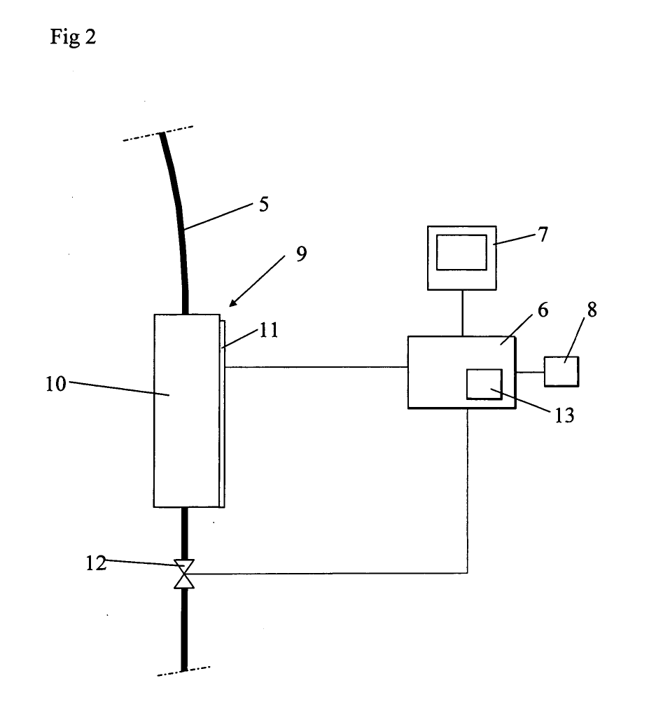

Furthermore, the device according to the invention comprises evaluating or appreciating means 9, one for each teatcup 1-4. The construction and function of the evaluating or appreciating means 9 may vary according to different embodiments of the present invention. FIG. 2 discloses an evaluating or appreciating means 9 in the form of a milk measuring device comprising a container 10 arranged to collect the milk produced during one milking operation. The milk measuring device comprises a sensor 11 arranged to sense the quantity of milk collected during the milking operation and transfer the sensed quantity to the processing unit 6. When the processing unit 6 has registered the milk quantity, a valve 12 is opened in order to convey the milk collected to the milk-receiving member of the milking machine. It is to be noted that also other types of milk measuring devices may be employed when realising the present invention, for instance the liquid measuring device disclosed in U.S. Pat. No. 5,116,119.

The processing unit 6, the display member 7, the time measuring unit 8 and the evaluating or appreciating means 9 may be included in the control system 21 of the milking arrangement.

The evaluating or appreciating means 9 may also be realised by a device merely arranged to indicate whether there is a milk flow or not. Such a device is for instance disclosed in EP-B-137 367 mentioned above. Thereby the time measuring unit 8 may be arranged to measure the duration of the milking period, i.e. the time interval from the beginning of the milk flow through the conduit 5 until the end of the milk flow. It is appreciated that the duration of the milking operation reflects the quantity of milk produced during said milking operation, i.e. the interval appreciated forms said parameter.

According to an embodiment, the processing unit 6 is arranged to compare said parameter related to the quantity of milk from the two front teatcups 1, 4 or from the two rear teatcups 2, 3. In this case no time measuring unit 8 is necessary. Merely the fact that the quantity of milk form one of the front teats or the rear teats deviates from the other front teat and rear teat, respectively, is an indication that the actual teat may be inflamed by mastitis.

According to another embodiment, the processing unit 6 is arranged to compare said parameter between the actual milking operation and at least one previous milking operation. A deviation in quantity in the actual milking operation is an indication that the teat may be inflamed by mastitis. In this embodiment the processing unit 6 comprises a memory 13 arranged to store historical data regarding said parameter of one or more previous milking operations for each teat. Preferably, an average value of said parameter of a great number of previous milking operations may be calculated by means of the processing unit 6. This average value may then be stored in the memory 13 and included in said comparison value.

It is to be noted that the comparison value is based on the parameter of another teat during one milking operation but historical data from one or several preceding milking operations may also be considered, as a supplementary information, when defining the comparison value in order to reduce any source of error. Such historical data may include various parameters, such as the rest milk quantity in each udder quarter, the time length of the previous milking operation for each individual udder quarter, any animal-specific fact, such as an injured teat, the time length of the immediately preceding milking interval, etc.

There are different sources of error, which possibly could lead to an indication of a disease in an udder quarter although this udder quarter is not affected. For instance, in case the milking of one udder quarter for any reason is not finished in the preceding milking operation, the present milking operation may result in a larger milk quantity from this udder quarter than from the other udder quarters of the animal. This is the case, especially in so called Voluntary Milking Systems, VMS, where the teatcups are applied in an automatic manner by means of the automatic handling device to the teats of the animal. In such a milking system, it is for the animals themselves to decide when they are to be milked. Consequently, the time interval between successive milking operations could vary and in some cases be very short.

It is also important to note that in a Voluntary Milking System, the milking of the animals is normally not fully completed, i.e. there is always a certain rest quantity left in at least some of the udder quarters after the teatcups have been removed from the teats and the milking operation has been finished. This rest quantity may vary between different udder quarters of the animal due to several reasons. For instance, it is common to interrupt the milking operation already when the milking of some, for instance two or three, of the udder quarters is considered to be finished. It is clear that in such a case, there will be a varying quantity of rest milk in the udder quarters. The time duration of the milking of different udder quarters may also vary for various reasons, for instance due to the fact that the teatcup is kicked-off by the cow herself, or the fact that the milking operation is deliberately interrupted by the system when the milking of only one or some of the udder quarters has been finished. Such varying milking times can result in a varying milking yield and a varying rest quantity between different udder quarters.

Such varying milking yields and rest quantities may be taken into account and included the historical data from one or several preceding milking operations when defining the comparison value.

Furthermore, it is to be noted that different udder quarters of the animal may be milked with different values for various milking parameters, such as milking vacuum level, pulsating frequency, pulsating vacuum levels, etc. Such parameters, which are normally pre-set milking parameters determined in advance, thus form further historical data that could be considered. Such varying parameters may also lead to different milking yields and different rest milk quantities in the different udder quarters.

It is also possible to define said parameter as the quantity of milk produced during a determined period of time by one teat of an animal, for instance during 24 hours, or by the total duration of milking during a determined period of time, i.e. the total time period when milk is actually flowing from a teat during 24 hours.

The present invention is not limited to the embodiments described above but may be varied and modified within the scope of the following claims.

1. A device for detecting a disease of the udder of an animal, comprising means for appreciating a parameter related to the quantity of milk extracted from a first teat and at least a second teat of said animal during at least one milking operation, means arranged to determine a deviation of said parameter of the first teat from a comparison value, and means arranged to display said deviation as an indication of an inflammation of the first teat at least in the case that said deviation exceeds a certain level, wherein the determining means is arranged to define said comparison value by including the level of said parameter regarding said second teat during said milking operation, wherein historical data, including pre-set milking parameters and/or data from one or several preceding milking operations, is considered when defining said comparison value.

2. A device according to claim 1, wherein the first teat and said second teat form one of a rearward pair of teats of the udder or a forward pair of teats of the udder.

3. A device according to claim 1 wherein said comparison value includes the level of said parameter of at least one preceding milking operation of said animal.

4. A device according to claim 3, wherein the determining means is arranged to consider the time interval between the milking operation and the immediately preceding milking operation of said animal for determining said deviation.

5. A device according to claim 1, wherein, characterized in that said parameter includes the quantity of milk produced during said milking operation and that the appreciating means includes a milk measuring device.

6. A device according to claim 1, wherein the milk measuring device includes a flow meter.

7. A device according claim 1, wherein said parameter includes the time duration of said milking operation and that the appreciating means includes a time measuring device.

8. A method of detecting a disease of the udder of an animal, comprising the steps of:
appreciating a parameter related to the quantity of milk extracted from a first teat and at least a second teat of said animal during at least one milking operation,
defining a comparison value by the level of said parameter regarding said second teat during said milking operation,
determining a deviation of said parameter of the first teat from said comparison value, and
indicating an inflammation of the first teat at least in the case that said deviation exceeds a certain level, wherein historical data,
including pre-set milking parameters and/or data from one or several preceding milking operations, is considered when defining said comparison value.

9. A method according to claim 8, comprising the further step of:
displaying said deviation as an indication of an inflammation of the first teat in the case that said deviation exceeds a certain level.

10. A method according to claim 8, wherein the first said teat and said second teat form one of a rearward pair of teats of the udder or a forward pair of teats of the udder.

11. A method according to claim 8, wherein said comparison value includes the level of said parameter of at least one preceding milking operation of said animal.

12. A method according to claim 11, further comprising the step of:
considering the time interval between said milking operation and the nearest preceding milking operation of said animal when determining said deviation.

13. A method according to claim 8, wherein said appreciating step includes measuring the quantity of milk extracted from the actual teat during said milking operation.

14. A method according to claim 8, wherein said appreciating step includes measuring the time duration of one milking operation of the actual teat.

15. A milking arrangement comprising a device for detecting a disease of the udder of an animal, the device comprising
means for appreciating a parameter related to the quantity of milk extracted from a first teat and at least a second teat of said animal during at least one milking operation,
means arranged to determine a deviation of said parameter of the first teat from a comparison value, and
means arranged to display said deviation as an indication of an inflammation of the first teat at least in the case that said deviation exceeds a certain level, characterized in that the determining means is arranged to define said comparison value by including the level of said parameter regarding said second teat during said milking operation, wherein historical data, including pre-set milking parameters and/or data from one or several preceding milking operations, is considered when defining said comparison value.

16. A milking arrangement according to claim 15, characterized in that the arrangement comprises an automatic handling device for automatic attachment of the teatcups to the teats of an animal.

17. A milking arrangement according to claim 15, characterized in that the arrangement comprises a control system for automatic supervision and control of the milking process.
